(19) United States
(12) Patent Application Publication
(10) Pub. No.: US 2007/0046836 A1
(43) Pub. Date: Mar. 1, 2007

(54) ROF link apparatus for selecting IF band to process service signals through MMF and method for selecting IF band

(75) Inventors: Sung-Kee Kim, Suwon-si (KR); Seong-Taek Hwang, Pyeongtaek-si (KR); Byung-Jik Kim, Seongnam-si (KR); Sang-Ho Kim, Hwaseong-si (KR); Gyu-Woong Lee, Suwon-si (KR); Jae-Hoon Lee, Seoul (KR); Yong-Gyoo Kim, Seoul (KR); Han-Lim Lee, Seoul (KR); Hoon Kim, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/504,858

(22) Filed: Aug. 16, 2006

(30) Foreign Application Priority Data
Aug. 25, 2005 (KR) 2005-78503

(51) Int. Cl. H04N 5/50

(52) U.S. Cl. 348/731

(57) ABSTRACT

Disclosed is an ROF link apparatus for selecting an IF band in order to process various service signals through an MMF, which including transmitters for receiving the service signals, performing IF modulation for the service signals, and transferring the modulated IF signals, a first controller for scanning frequency characteristics of the MMF, searching for flat frequency bands, and transferring information regarding the flat frequency band, thereby controlling IF modulation to be performed, a link unit for combining the IF signals with output signals of the first controller, converting the combined signals into optical signals, transmitting the optical signals, converting the optical signals into electrical signals, and splitting the electrical signals, a second controller for receiving the output signals of the first controller, detecting information regarding the flat frequency band, and transferring the information to receivers, thereby controlling modulation to be performed, and the receivers for receiving the IF modulated signals, receiving the information from the second controller, and performing RF modulation.

### CLAIM OF PRIORITY

This application claims the benefit of the earlier filing date, pursuant to 35 USC § 119, to that patent application entitled “ROF Link Apparatus For Selecting IF Band In Order To Process Various Service Signals Through MMF And Method For Selecting IF Band,” filed in the Korean Intellectual Property Office on Aug. 25, 2005 and assigned Serial No. 2005-78503, the contents of which are hereby incorporated by reference.

### BACKGROUND OF THE INVENTION

1. Field of the Invention

The present invention relates to a Radio over Fiber (ROF) link apparatus for selecting an Intermediate Frequency (IF) band in order to process various service signals through a Multi-mode Fiber (MMF) and a method for selecting the IF band.

2. Description of the Related Art

With the diversification and rapid increase of an information communication service, optical communication technology is being integrated with wireless communication technology. Interest in optical-wireless communication technology, which applies ultra high frequencies to an ultra high speed optical communication network to process different types of mass storage multimedia information communication services through integration of wire communication technology with wireless communication technology, has increased. In addition, integration technology obtained by integrating the wire communication technology with the wireless communication technology, i.e. ROF technology, which uses both optical communication technology and wireless technology for mobility to support high speed transmission, has been actively researched.

Since an ROF system is advantageous in view of the broadband trend of channel capacity, low cost, low power, easy installation, maintenance, etc., the ROF system provides an appropriate solution for a ultra high speed wireless multimedia service in either an indoor application, e.g., an airport terminal, a shopping center or a large office, or an outdoor application, e.g., an underground terminal, a narrow street or a highway.

ROF links are generally constructed by using a Single-mode Fiber (SMF) as an optical fiber has a sufficiently wide band and can be used for long distance transmission due to low chromatic dispersion. However, coupling efficiency may significantly deteriorate in connection with a light emitting element or a light receiving element due to the small core radius of an SMF.

Accordingly, technology has been proposed, which may be effectively used for short distance by improving coupling efficiency through the application of a multiple-mode fiber (MMF).

FIG. 1 is a graph illustrating the general amplitude response characteristics as a function of frequency of an MMF.

As illustrated in FIG. 1, in the case of the MMF, it can be understood that a 3 dB band, which is a typical transmission band, is narrowly formed due to a dispersion effect among the modes.

In FIG. 1, the horizontal axis represents a frequency axis and the vertical axis represents an amplitude response characteristic. It would be recognized that the MMF possesses an amplitude characteristic wherein the amplitude monotonously decreases in a low frequency band, i.e. a 3 dB band 11, and has an irregular amplitude characteristic as a frequency increases. Such an irregular amplitude characteristic changes according to the lengths and connection states of the MMF due to coupling among the modes.

Further, it is impossible to transfer signals reliably through a frequency band greater than the 3 dB band, 11, having an irregular amplitude characteristic. Therefore, the conventional ROF link has been formed by means of an IF contained within the 3 dB band.

According to the prior art as described above, a transmission link has been formed within the 3 dB band of the MMF. Therefore, a bandwidth is not sufficient for simultaneously supporting various services.

### SUMMARY OF THE INVENTION

Accordingly, the present invention has been made to solve the above-mentioned problems and an object of the present invention is to provide an ROF link apparatus for selecting an IF band in order to process various service signals through an MMF and a method for selecting the IF band, in which, when an ROF link is formed by using an MMF, signals can be transferred through a frequency band exceeding a 3 dB band of the MMF so that various services can be simultaneously supported.

In accordance with one aspect of the present invention, there is provided a Radio over Fiber (ROF) link apparatus for selecting an Intermediate Frequency (IF) band in order to process various service signals through a Multi-mode Fiber (MMF), the ROF link apparatus including a plurality of transmitters for receiving the various service signals, performing IF modulation for the various service signals, and transferring the modulated IF signals, a first controller storing information regarding substantially flat amplitude characteristics of the MMF frequency band, and transferring information on the substantially flat amplitude frequency bands to the transmitters, thereby controlling IF modulation to be performed in the frequency bands, a link unit for combining the IF signals modulated by the transmitters with output signals of the first controller, converting the combined signals into optical signals, transmitting the optical signals, converting the optical signals into electrical signals, and splitting the electrical signals, a second controller for receiving the output signals of the first controller, which have been split through the link unit, detecting information on IF modulation frequencies of the transmitters, respectively, and transferring the detected information to a plurality of receivers, thereby controlling modulation to be performed in a preset RF band, and the receivers for receiving the IF modulated signals, which have been split through the link unit, receiving the information on the IF modulation frequencies from the second controller, and performing demodulation on the received information.

In accordance with another aspect of the present invention, there is provided a method for selecting an Intermediate Frequency (IF) band in a Radio over Fiber (ROF) link apparatus for selecting the IF band in order to process various service signals through a Multi-mode Fiber (MMF), the method including the steps of scanning an amplitude of signals in frequency bands except for a 3 dB band of the MMF, detecting flat bands of more than a predetermined size from the frequency characteristics scanned, assigning signals to be transmitted through the detected flat bands, and transmitting IF modulated signals through the 3 dB band and the detected flat bands.

### BRIEF DESCRIPTION OF THE DRAWINGS

The above features and advantages of the present invention will be more apparent from the following detailed description taken in conjunction with the accompanying drawings, in which:

FIG. 1 is a graph illustrating the general frequency characteristics of an MMF;

FIG. 2 is a graph illustrating a signal transmission band using the frequency characteristics of an MMF according to one embodiment of the present invention;

FIG. 3 is a block diagram illustrating an ROF link apparatus for processing various service signals through an MMF according to one embodiment of the present invention; and

FIG. 4 is a block diagram illustrating the selection and control method of an IF band according to one embodiment of the present invention.

### DETAILED DESCRIPTION OF THE INVENTION

Now, an embodiment of the present invention will be described in detail herein below with reference to the accompanying drawings. The same reference numerals are used to designate the same elements as those shown in other drawings.

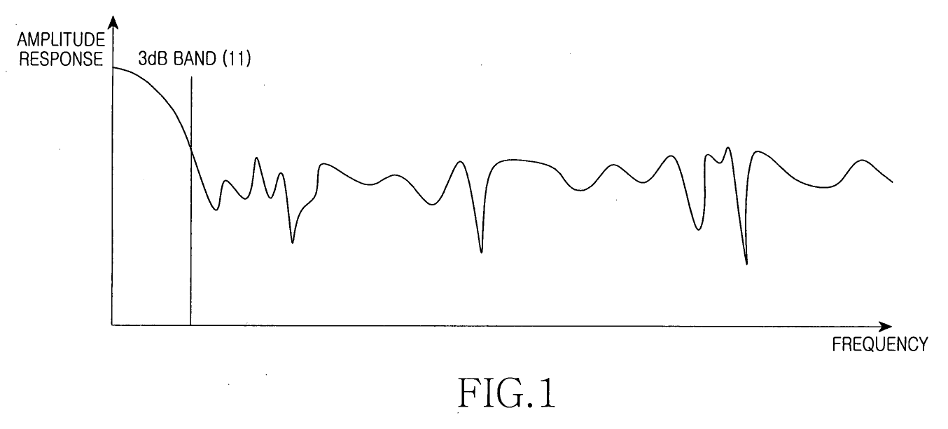

In the present invention, in the case of forming an ROF link by using an MMF, it is necessary to use the frequency characteristics of the MMF as illustrated in FIG. 1 in order to provide both a method for selecting an IF band for signal transmission in the MMF, which enables signals to be transferred through a frequency band other than the 3 dB transmission band of the MMF so as to simultaneously support various services, and a transmission apparatus to which the method is applied.

However, in the frequency band other than the 3 dB transmission band as illustrated in FIG. 1, since the amplitude characteristics change according to the fiber lengths and connection states of the MMF due to coupling among modes and non-linearity appears, it is difficult to find and use generalized characteristics. Nevertheless, it can be understood that a band having a linear characteristic, in which signals can be transferred, also exists in the frequency band other than the 3 dB transmission band.

Accordingly, the present invention is characterized in that a band having a linear (substantially flat) characteristic in the frequency band other than the 3 dB transmission band is searched for and an ROF link is formed to transfer predetermined signals through the band.

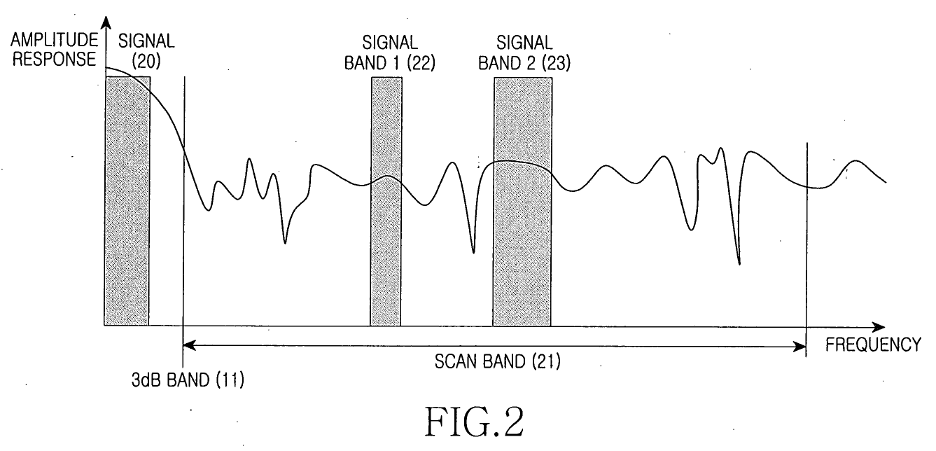

FIG. 2 is a graph illustrating a signal transmission band using the amplitude/frequency characteristics of an MMF according to one embodiment of the present invention.

Referring to FIG. 2, the basic amplitude/frequency characteristics are the same as that described in FIG. 1. That is, it can be understood that the 3 dB transmission B band 11, which is the typical transmission band, is narrowly formed. In FIG. 2, the horizontal axis indicates a frequency axis and the vertical axis indicates an amplitude response characteristic. Specifically, it would be recognized that the MMF has a characteristic in which a amplitude response monotonously decreases in a low frequency, i.e. the 3 dB transmission band 11, and has an irregular characteristic as the frequency increases. Such an irregular characteristic changes according to the lengths and connection states of the MMF due to coupling among modes.

However, as illustrated in FIG. 2, it would be recognized that predetermined bands 22 and 23 also have linear (i.e., substantially flat) amplitude characteristics in the frequency band exceeding the 3 dB band 11.

Such bands having linear amplitude characteristics are designated as the first signal band 22 and the second signal band 23 so that signals can be transmitted in these bands. In order to find the bands having the linear amplitude response characteristics in the frequency band other than the 3 dB band 11, it is necessary to search for frequency characteristics thereof. To this end, a predetermined frequency band, except for the 3 dB band 11, is set as a scan band 21, and bands having the linear characteristics equal to those of the signal bands 22 and 23 are determined through scanning for the amplitude response characteristics in the corresponding scan band 21. Such scanning is performed by the transmitter of an ROF link altering a transmission frequency and measuring the amplitude response characteristics of the MMF. Further, an IF band proper for signal transmission according to the frequency characteristics may be selected, so that signal transmission performance can be maximized.

That is, as illustrated in FIG. 2, the bands having the linear amplitude characteristics are selected as IF bands. In one aspect of the invention, linear amplitude characteristics may be determined when each of the amplitudes in a frequency band are within a known tolerance, e.g., 3 db. Herein, the IF bands may also be determined when the ROF link is first installed or changes. Otherwise, it is also possible to design another IF band to be automatically used when performance falls below a preset criterion.

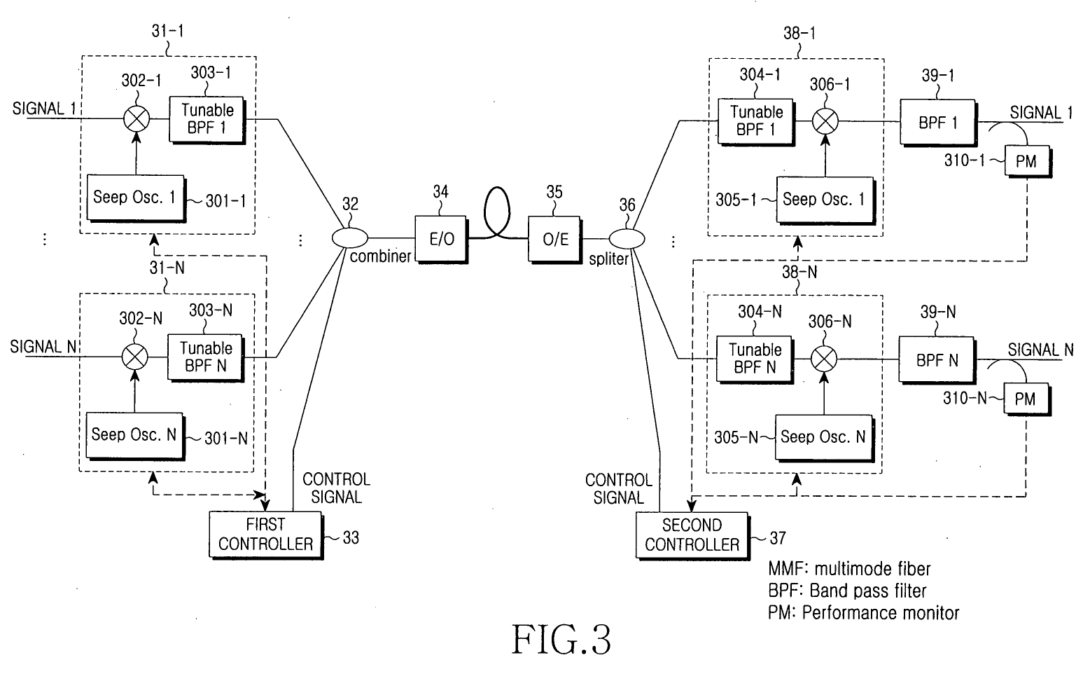

FIG. 3 represents a block diagram illustrating an ROF link apparatus for processing various service signals through an MMF according to one embodiment of the present invention.

As illustrated in FIG. 3, the ROF link apparatus according to the embodiment of the present invention determines an IF band(s) for transmission when the system is initialized or altered, in order to transmit various input service signals 1 to N. Information on the determined IF band(s) is stored through a first controller 33.

Further, the ROF link apparatus includes ROF transmitters 31-1 to 31-N and ROF receivers 38-1 to 38-N. The ROF transmitters 31-1 to 31-N include seep oscillators 301-1 to 301-N, multipliers 302-1 to 302-N, and tunable Band Pass Filters (BPFs) 303-1 to 303-N, respectively. Each of the seep oscillators 301-1 to 301-N receives information on a preset IF band through the first controller 33 and provides frequency components of the corresponding IF band for IF modulation in the corresponding IF band by means of the information (data). Each of the multipliers 302-1 to 302-N performs IF modulation by respectively combining the input service signals 1 to N with the IF frequency components of the seep oscillators 301-1 to 301-N. Each of the tunable BPFs 303-1 to 303-N filters the signals on the IF band modulated through the multipliers 302-1 to 302-N. Further, the ROF receivers 38-1 to 38-N include tunable BPFs 304-1 to 304-N, the seep oscillators 305-1 to 305-N, and multipliers 306-1 to 306-N, respectively. Each of the tunable BPFs 304-1 to 304-N filters the signals on the IF band modulated by and transferred from the ROF transmitters 31-1 to 31-N. Each of the seep oscillators 305-1 to 305-N receives information on a preset IF band through a second controller 37, and provides frequency components of a (RF-IF) band in order to modulate the corresponding IF band into an RF band. Each of the multipliers 306-1 to 306-N performs RF demodulation by respectively combining the signals on the IF band, which are received through the tunable BPFs 304-1 to 304-N, with the (RF-IF) frequency components of the seep oscillators 305-1 to 305-N.

A construction equal to that of a general ROF link is provided between the ROF transmitters 31-1 to 31-N and the ROF receivers 38-1 to 38-N. That is, a combiner 32, an electrooptic converter 34, an optoelectric converter 35, and a splitter 36 are provided. The combiner 32 combines the output of the ROF transmitters 31-1 to 31-N with output signals of the first controller 33. The electrooptic converter 34 converts the output of the combiner 32 into optical signals and transfers the optical signals through an MMF. The optoelectric converter 35 receives the optical signals transferred through the MMF and converts the optical signals into electric signals. The splitter 36 splits the electric signals converted through the optoelectric converter 35 and inputs the split signals to the ROF receivers 38-1 to 38-N and the second controller 37.

The second controller 37 receives information on the IF band having been set for respective signals from the first controller 33, and transfers the received information to the ROF receivers 38-1 to 38-N, thereby controlling the setup of the seep oscillators 305-1 to 305-N and the tunable BPFs 304-1 to 304-N for demodulation to the frequency band.

The signals output from the ROF receivers 38-1 to 38-N are output as radio signals through BPFs 39-1 to 39-N for passing only the signals on the specific frequency band.

In order to determine if the IF band has been normally selected, it is possible to additionally provide Performance Monitors (PMs) 310-1 to 310-N after the BPFs 39-1 to 39-N. In the aspect of the present invention, a reception RF power monitor is used as the PM. However, the present invention is not limited to this case. It is apparent to those skilled in the art that various apparatuses may be proposed for performance monitoring. Further, information on performance obtained through the PMs 310-1 to 310-N is transferred to the second controller 37. The second controller 37 collects the results and transfers the collected results to the first controller 33. In this way, when performance deteriorates, an operation including reselection of the IF band, etc., can be accomplished.

The present invention proposes two embodiments for selecting each IF band through the first controller 33.

In a first embodiment, the size of an IF bandwidth, which is to be set in the initialization or change of a system, is divided pursuant to a predetermined criterion, and then the IF band is selected by sequential search of the IF band in the scan area. That is, an IF band of more than a predetermined size is searched for in the entire scan area, and then an IF band of less than the predetermined size is searched for in the entire scan area. In this way, the IF band can be selected according to its size.

In a second embodiment, the minimum size of an IF bandwidth, which is to be set in the initialization or change of a system, is determined. Then, bands of more than the minimum size are stored in a sequence in which the bands are detected. However, since signals must be assigned according to the size of a bandwidth, a separate control process for the assignment is necessary.

The IF band selected through the scanning process is modulated into a corresponding frequency and transmitted through the transmitter. Then, the receiver performs RF demodulation for the IF band by means of a corresponding frequency, and feedbacks performance based on the results of the RF demodulation. In this way, it is possible to determine if the selection effectively has been accomplished. Accordingly, the selection process of the IF band is performed including a determination step through such a feedback process. For such feedback, the embodiment of the present invention includes the PMs 310-1 to 310-N.

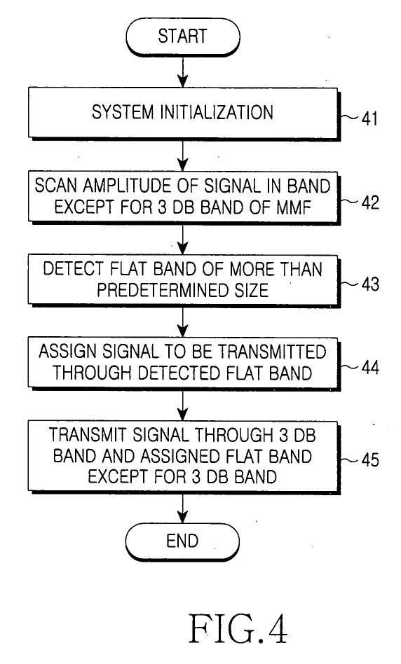

FIG. 4 is a block diagram illustrating the selection and control method of the IF band according to one embodiment of the present invention.

As illustrated in FIG. 4, if a system is initialized or altered at step 41, the amplitude of signals regarding frequency characteristics is scanned in bands except for the 3 dB transmission band 11 of the MMF at step 42. That is, the amplitude/frequency characteristics are searched.

Then, flat bands of more than a predetermined frequency size are determined from the scanned amplitude/frequency characteristics at step 43. This method follows the second embodiment as described above. In the case of following the first embodiment, a process is necessary, in which flat bands are classified according to sizes in the scanned frequency characteristics.

Further, signals to be transmitted through the detected flat bands are assigned at step 44.

Then, IF-modulated signals are transmitted through the 3 transmission dB band and the assigned flat bands except for the 3 dB band at step 45.

For processing in the receiver as in the construction of FIG. 3, information on such assigned signals and the characteristics of the flat bands is transferred to the second controller 37 through the first controller 33, so that corresponding processing can be accomplished.

The above-described method according to the present invention can be realized as software and can be stored in a recording medium such as a CD ROM, an RAM, a floppy disk, a hard disk or a magneto-optical disk, so that a user can read such software by using a computer. Or the software may be downloaded over a network.

According to the present invention as described above, various service signals can be simultaneously processed by means of an ROF link using an MMF.

Specifically, in order to compensate for the 3 dB bandwidth of the MMF, which is not sufficient for simultaneously supporting various service signals, an IF band is searched for from bands except for the 3 dB bandwidth. Consequently, additional performance can be achieved regardless of the type, length and connection state of the MMF.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A Radio over Fiber (ROF) link apparatus for selecting an Intermediate Frequency (IF) band in order to process various service signals through a Multi-mode Fiber (MMF), the ROF link apparatus comprising:
a plurality of transmitters for receiving the various service signals for performing IF modulation for the various service signals, and transferring the modulated IF signals;
a first controller containing information regarding frequency bands of substantially flat amplitude in the amplitude/frequency characteristics of the MMF, and transferring information regarding the frequency bands of substantially flat amplitude to the transmitters for controlling IF modulation;
a link unit for combining the IF signals modulated by the transmitters with output signals of the first controller, converting the combined signals into optical signals, transmitting the optical signals, converting the optical signals into electrical signals, and splitting the electrical signals;
a second controller for receiving the output signals of the first controller, detecting information on IF modulation frequencies of the transmitters and transferring the detected information to a plurality of receivers, thereby controlling demodulation to be performed in the substantially flat amplitude frequency bands; and
the receivers for receiving the IF modulated signals, which have been split through the link unit, receiving the information on the IF modulation frequencies from the second controller, and performing demodulation in the flat frequency bands by means of the received information.

2. The ROF link apparatus as claimed in claim 1, wherein each of the transmitters comprises:
a seep oscillator for receiving the information regarding the flat amplitude frequency bands from the first controller, and providing frequency components of the flat frequency bands for the IF modulation in the flat frequency bands;
a multiplier for performing the IF modulation by respectively combining selected ones of the various service signals with the frequency components of the seep oscillator; and
a Band Pass Filter (BPF) for filtering signals on an IF band modulated through the multiplier.

3. The ROF link apparatus as claimed in claim 1, wherein the link unit comprises:
a combiner for combining the output of the transmitters with the output signals of the first controller;
an electrooptic converter for converting output of the combiner into optical signals and transferring the optical signals through an MMF;
an optoelectric converter for receiving the optical signals transferred through the MMF and converting the optical signals into electric signals; and
a splitter for splitting the electric signals converted through the optoelectric converter and inputting the split signals to the receivers and the second controller, respectively.

4. The ROF link apparatus as claimed in claim 1, wherein each of the receivers comprises:
a band-pass filter (BFP) for receiving the IF modulated signals, which have been split through the link unit, receiving the information on the IF modulation frequencies from the second controller, and performing filtering of the IF modulation frequency bands;
a seep oscillator for receiving the information on the IF modulation frequencies from the second controller, and providing frequency components of a (RF-IF) band for modulation in a preset RF band; and
a multiplier for performing the demodulation by combining the IF modulated signals, which are received through the BPF, with (RF-IF) frequency components of the seep oscillator.

5. The ROF link apparatus as claimed in claim 4, further comprises a BPF for removing signals out of a corresponding RF band from RF modulation signals output through the multiplier.

6. The ROF link apparatus as claimed in claim 1, further comprises:
a Performance Monitor (PM) for performing performance monitoring for the RF signals modulated by the receivers, and transferring results of the performance monitoring to the first controller through the second controller, thereby allowing performance of the selected IF band to be checked.

7. A method for selecting an Intermediate Frequency (IF) band in a Radio over Fiber (ROF) link apparatus for selecting the IF band in order to process various service signals through a Multi-mode Fiber (MMF), the method comprising the steps of:
scanning an amplitude characteristics of signals in frequency bands except for a 3 dB band of the MMF;
detecting flat amplitude bands of more than a predetermined frequency size from the scanned characteristics;
assigning signals to be transmitted through the flat bands detected; and
transmitting IF modulated signals through the 3 dB band and the detected flat bands.

8. The method as claimed in claim 7, wherein the step of detecting comprises the steps of:
classifying sizes of substantially flat amplitude frequency bands according to the signals to be transmitted; and
detecting the scanned characteristics according to the classified sizes of the substantially flat amplitude

9. The apparatus as claimed in claim 1, further comprising:
scanning means for determining the amplitude characteristics as a function of frequency of the MMF; and
storing information in the first controller of substantially flat amplitude characteristics over a predetermined frequency band.

10. The apparatus as claimed in claim 1, wherein the output signals of the first controller include information regarding the substantially flat frequency bands.

11. A Radio over Fiber (ROF) link apparatus for selecting an Intermediate Frequency (IF) band in order to process plurality of service signals through a Multi-mode Fiber (MMF), the ROF link apparatus comprising:
a plurality of transmitters, receiving selected ones of the plurality of service signals, each transmitter performing IF modulation for the corresponding service signals, and transferring the modulated IF signals,
a first controller containing information regarding frequency bands of substantially flat amplitude in the amplitude/frequency characteristics of the MMF, and transferring information regarding the frequency bands of substantially flat amplitude to the transmitters for controlling IF modulation; and
a link unit for combining the IF signals with output signals of the first controller.

12. The apparatus claimed in claim 11, wherein the first controller output signals comprise the information regarding the substantially flat amplitude frequency bands.

13. The ROF link apparatus as claimed in claim 11, further comprising:
means for scanning frequency characteristics of the MMF;
means determining substantially flat amplitude frequency bands within the frequency characteristics of the MMF; and
means for storing information regarding the determined substantially flat amplitude frequency bands in the first controller.

14. The ROF link apparatus as claimed in claim 13, wherein the substantially flat amplitude frequency bands exceed a predetermined size.

15. The ROF link apparatus as claimed in claim 14, wherein the substantially flat amplitude frequency bands are sorted by decreasing band size.

16. The ROF link apparatus as claimed in claim 11, wherein the amplitudes within the flat amplitude bands are determined as being with a known tolerance.

17. The ROF link apparatus as claimed in claim 11, further comprising:
means for receiving results of performance monitoring for allowing performance of the selected IF band to be checked.
